(19) United States
(12) Patent Application Publication
(10) Pub. No.: US 2024/0253525 A1
(43) Pub. Date: Aug. 1, 2024

(54) CONTROL DEVICE FOR VEHICLE

(71) Applicant: Honda Motor Co., Ltd., Tokyo (JP)

(72) Inventor: Minoru TORII, Tokyo (JP)

(73) Assignee: Honda Motor Co., Ltd., Tokyo (JP)

(21) Appl. No.: 18/420,194

(22) Filed: Jan. 23, 2024

(30) Foreign Application Priority Data
Jan. 27, 2023 (JP) 2023-011006

(51) Int. Cl. B60L 58/22

(52) U.S. Cl. CPC B60L 58/22

(57) ABSTRACT

A control device for a vehicle includes: a first controller; and a second controller controlled by the first controller. The first controller is configured to transmit information used for first processing necessary for travel control of the vehicle to the second controller, the second controller is configured to perform the first processing based on the information received from the first controller, and transmit a result of the first processing to the first controller, and the first controller is configured to perform travel control of the vehicle based on the result received from the second controller.

### CROSS-REFERENCE RELATED APPLICATIONS

This application is based on and claims priority under 35 USC 119 from Japanese Patent Application No. 2023-011006 filed on Jan. 27, 2023, the contents of which are incorporated herein by reference.

### TECHNICAL FIELD

The present disclosure relates to a control device for a vehicle.

### BACKGROUND

In recent years, efforts have been actively made to provide access to a sustainable transportation system in consideration of vulnerable people among traffic participants. In order to implement the above, focus has been placed on research and development on further improving safety and convenience of traffic by research and development related to automatic driving technique.

Japanese Patent Application Laid-open Publication No. 2019-156192 describes a control device for a vehicle, the control device including: an external environment recognition unit that recognizes a surrounding state of a host vehicle, an action planning unit that determines an action that the host vehicle is to take based on a recognition result of the external environment recognition unit, and a vehicle control unit that performs travel control of the host vehicle based on a determination result of the action planning unit.

A large number of types of processing is required to control a vehicle for automatic driving and the like.

As a load on a processor that performs these types of processing increases, a cost of countermeasures against heat generation and the like of the processor increases.

The present disclosure aims to reduce a manufacturing cost of a vehicle. By extension, the present disclosure contributes to development of a sustainable transportation system.

### SUMMARY

One aspect of the present disclosure relates to a control device for a vehicle, the control device including:
a first controller; and
a second controller controlled by the first controller, in which
the first controller is configured to transmit information used for first processing necessary for travel control of the vehicle to the second controller,
the second controller is configured to perform the first processing based on the information received from the first controller, and transmit a result of the first processing to the first controller, and
the first controller is configured to perform travel control of the vehicle based on the result received from the second controller.

### BRIEF DESCRIPTION OF DRAWINGS

Exemplary embodiment of the present invention will be described in detail based on the following figures, wherein:

FIG. 1 is a diagram showing a vehicle 1 controlled by a control device according to an embodiment of the present disclosure;

FIG. 2 is a schematic diagram showing an example of a distribution destination of processing A;

FIG. 3 is a schematic diagram showing another example of the distribution destination of the processing A;

FIG. 4 is a schematic diagram showing another example of the distribution destination of the processing A;

FIG. 5 is a schematic diagram showing another example of the distribution destination of the processing A;

FIG. 6 is a schematic diagram showing another example of the distribution destination of the processing A; and

FIG. 7 is a schematic diagram showing an example of a distribution destination of processing B.

### DESCRIPTION OF EMBODIMENTS

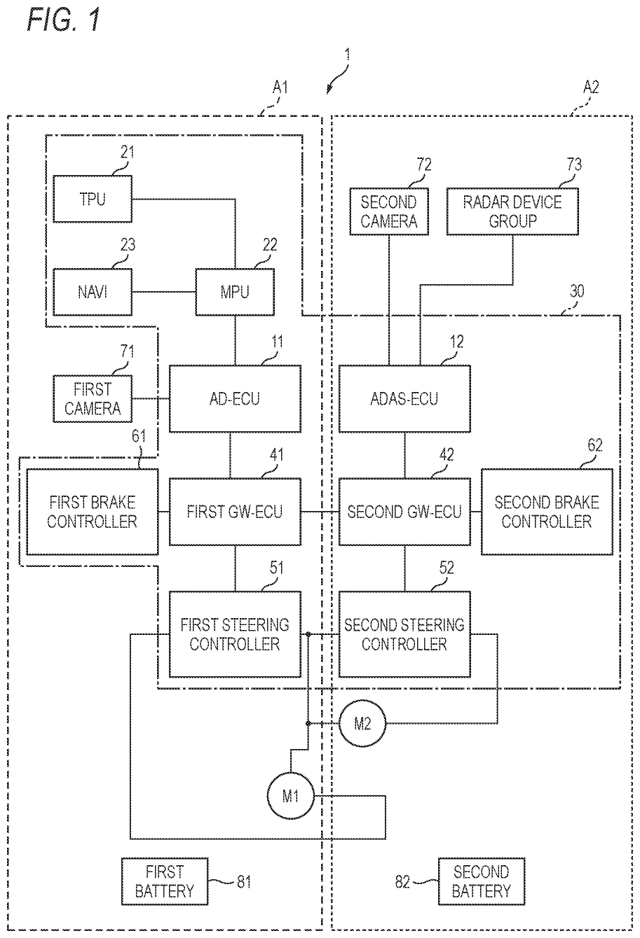

FIG. 1 is a diagram showing a vehicle 1 controlled by a control device according to an embodiment of the present disclosure. The vehicle 1 shown in FIG. 1 is an automobile including a drive source, and wheels (all not shown) including drive wheels driven by power of the drive source and steering wheels that are steerable. For example, the vehicle 1 is a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. Either one of the front wheels and the rear wheels may be steerable steering wheels, or both the front wheels and the rear wheels may be steerable steering wheels.

As shown in FIG. 1, the vehicle 1 includes a first battery 81 and a second battery 82 as power sources, and includes a first system A1 that operates with electric power supplied from the first battery 81 and a second system A2 that operates with electric power supplied from a second battery 82.

The vehicle 1 includes a control device 30. The control device 30 includes a plurality of control units including one or more processors. In the example of FIG. 1, the control device 30 includes an autonomous driving (AD)-electronic control unit (ECU) 11, an advanced driver assistance system (ADAS)-ECU 12, a telematics control unit (TPU) 21, a map positioning unit (MPU) 22, a navigation unit (NAVI) 23, a first gateway (GW)-ECU 41, a second GW-ECU 42, a first steering controller 51, a second steering controller 52, a first brake controller 61, and a second brake controller 62.

Each control unit included in the control device 30 includes a processor such as a central processing unit (CPU), an input and output unit, and a storage unit. The input and output unit is an interface that inputs and outputs data between inside and outside of the control unit under control of the processor. The storage unit includes a nonvolatile storage medium such as a flash memory, and stores operating programs of the processor and various data.

The ADAS-ECU 12 performs adaptive cruise control (ACC), lane keeping assistance, and the like.

In addition to the processor used in the ADAS-ECU 12, the AD-ECU 11 is equipped with a high-performance processor for processing a large amount of data necessary for image processing and various kinds of communication processing. The AD-ECU 11 performs hands-off control, automatic driving control during traffic jams, degeneration control during emergencies, and the like.

The TPU 21 is connected to an external device via wireless communication and controls downloading of various kinds of information. The TPU 21 is controlled by the AD-ECU 11 via the MPU 22.

The MPU 22 outputs map information around a host vehicle based on a position of the host vehicle calculated with high accuracy using satellite positioning, inertial navigation, and the like, recommended lane-level route information to a destination, and the like, to the AD-ECU 11, ADAS-ECU 12, or NAVI 23 to assist vehicle integrated control. The MPU 22 is controlled by the AD-ECU 11.

The NAVI 23 performs navigation of the vehicle 1 based on the position information of the vehicle 1 and the map information. The NAVI 23 also performs control to display various kinds of information necessary for the vehicle 1 on a display (not shown). The NAVI 23 is controlled by the AD-ECU 11 via the MPU 22.

The first GW-ECU 41 controls the first steering controller 51 and the first brake controller 61 based on control information received from the AD-ECU 11 and the ADAS-ECU 12 to change a steering angle and a braking force. The first GW-ECU 41 is controlled by the AD-ECU 11.

The second GW-ECU 42 controls the second steering controller 52 and the second brake controller 62 based on the control information received from the AD-ECU 11 and the ADAS-ECU 12 to change the steering angle and the braking force. The second GW-ECU 42 is controlled by the ADAS-ECU 12. The first GW-ECU 41 and the second GW-ECU 42 are arranged, for example, at separate positions (for example, in the center and in the front) of the vehicle 1.

The first steering controller 51 and the second steering controller 52 drive a first motor M1 or a second motor M2, which will be described later, based on an instruction from the first GW-ECU 41 or the second GW-ECU 42, so as to control the steering angle of the vehicle 1.

The first brake controller 61 and the second brake controller 62 control the braking force of the vehicle 1 by controlling a brake mechanism (not shown) or the like based on an instruction from the first GW-ECU 41 or the second GW-ECU 42.

The first steering controller 51 and the first brake controller 61 are controlled by the AD-ECU 11 via the first GW-ECU 41 and the second GW-ECU 42. The AD-ECU 11 can also control the second steering controller 52 and the second brake controller 62 via the second GW-ECU 42.

The second steering controller 52 and the second brake controller 62 are controlled by the ADAS-ECU 12 via the second GW-ECU 42. The ADAS-ECU 12 can also control the first steering controller 51 and the first brake controller 61 via the first GW-ECU 41 and the second GW-ECU 42.

The vehicle 1 further includes a sensor group used to recognize an external environment (white lines, objects, other vehicles, traffic lights, and the like). This sensor group includes a first camera 71 controlled by the AD-ECU 11, a second camera 72 controlled by the ADAS-ECU 12, and a radar device group 73 controlled by the ADAS-ECU 12. The sensor group acquires various detection values related to the vehicle 1 or a periphery of the vehicle 1. The detection values obtained by the sensor group are sent to the AD-ECU 11 or ADAS-ECU 12, and are used for travel control of the vehicle 1.

The vehicle 1 further includes the first motor M1 and the second motor M2 for driving a shaft connected to the wheels. The steering angle can be changed by driving either the first motor M1 or the second motor M2.

In the control device 30, the AD-ECU 11 constitutes a first control unit, and the TPU 21, MPU 22, NAVI 23, first GW-ECU 41, first steering controller 51, and first brake controller 61 each constitute a second control unit. In the control device 30, the ADAS-ECU 12 constitutes the first control unit, and the second GW-ECU 42, second steering controller 52, and second brake controller 62 each constitute the second control unit.

In the control device 30, the first GW-ECU 41 constitutes a first device, and the first steering controller 51 and the first brake controller 61 each constitute a second device. In the control device 30, the second GW-ECU 42 constitutes the first device, and the second steering controller 52 and the second brake controller 62 each constitute the second device.

In the vehicle 1, the first system A1 and the second system A2 operate with different batteries, such that even when an abnormality occurs in one of the first battery 81 and the second battery 82, the travel control of the vehicle 1 can be performed. As the sensor group, the first system A1 includes a first camera 71, and the second system A2 includes a second camera 72 and a radar device group 73. The first system A1 and the second system A2 each include a brake controller and a steering controller. Therefore, even when an abnormality occurs in one of the two steering controllers, the travel control can be continued using the other steering controller. Even when an abnormality occurs in one of the two brake controllers, the travel control can be continued using the other brake controller. Even when an abnormality occurs in one of the first camera 71 and the second camera 72, external environment sensing can be continued using the other camera.

The AD-ECU 11 can reduce a processing load by causing other control units (at least one of the TPU 21, MPU 22, NAVI 23, first GW-ECU 41, first steering controller 51, first brake controller 61, second GW-ECU 42, second steering controller 52, and second brake controller 62) in the control device 30 to execute one or some types (hereinafter referred to as processing A) of the processing necessary for the travel control of the vehicle 1 such as: various types of recognition processing around the vehicle 1 based on the output of the sensor group (target object recognition, white line recognition, other vehicle recognition, and the like); determination processing of steering angle, braking force, and the like based on a result of the recognition processing; and notification processing to the user based on a result of the recognition processing.

Similarly, the ADAS-ECU 12 can reduce a processing load by causing other control units (at least one of the first GW-ECU 41, first steering controller 51, first brake controller 61, second GW-ECU 42, second steering controller 52, and second brake controller 62) in the control device 30 to execute one or some types (hereinafter referred to as processing B) of the processing necessary for the travel control of the vehicle 1.

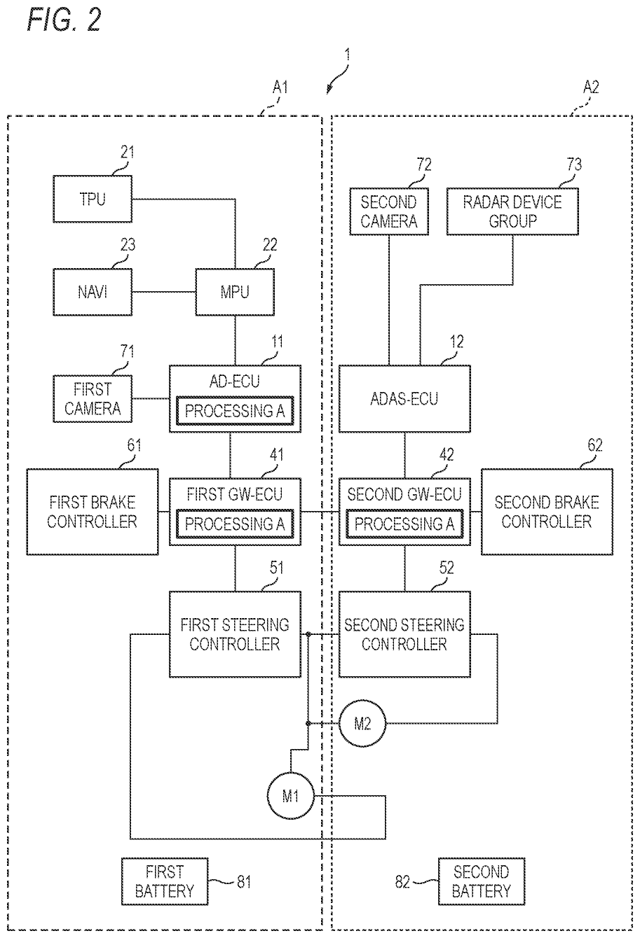

FIG. 2 is a schematic diagram showing an example of a distribution destination of the processing A. FIG. 2 shows an example in which the processing A to be performed by the AD-ECU 11 can be executed by each of the first GW-ECU 41 and the second GW-ECU 42.

The AD-ECU 11 executes the processing A by itself when its own processing load is equal to or lower than a threshold, and when its own processing load exceeds the threshold, at least one of the first GW-ECU 41 and the second GW-ECU 42 may be caused to execute the processing A instead. When the AD-ECU 11 causes a plurality of control units other than itself to execute the processing A, the AD-ECU 11 may select the one that can output a processing result earliest among the plurality of control units and cause that control unit to execute the processing A, or may cause each of the plurality of control units to execute the processing A, and select one of processing results sent from each control unit and use the one processing result for the travel control. The AD-ECU 11 may cause other control units to execute the processing A, and also execute the processing A itself, and select one of processing results to use for the travel control.

The AD-ECU 11 may send only information used for the processing A to other control units, and the other control units may execute the processing A based on the information received from the AD-ECU 11 and operation expressions included in their own operating programs. The AD-ECU 11 may send both the information used for the processing A and the operation expression for the processing A to other control units, and the other control units may execute the processing A using the information and the operation expression received from the AD-ECU 11.

According to the distribution example shown in FIG. 2, since the processing A can be distributed to a plurality of control units, the processing A can be executed more efficiently than a configuration in which the processing A can only be distributed to a single control unit, and as a result, the AD-ECU 11 can obtain the processing result at a high speed. Moreover, since the first GW-ECU 41 included in the first system A1 and the second GW-ECU 42 included in the second system 42 can execute the processing A, for example, if an abnormality occurs in the second battery 82, and each unit of the second system A2 becomes inoperable, the processing A can still be distributed.

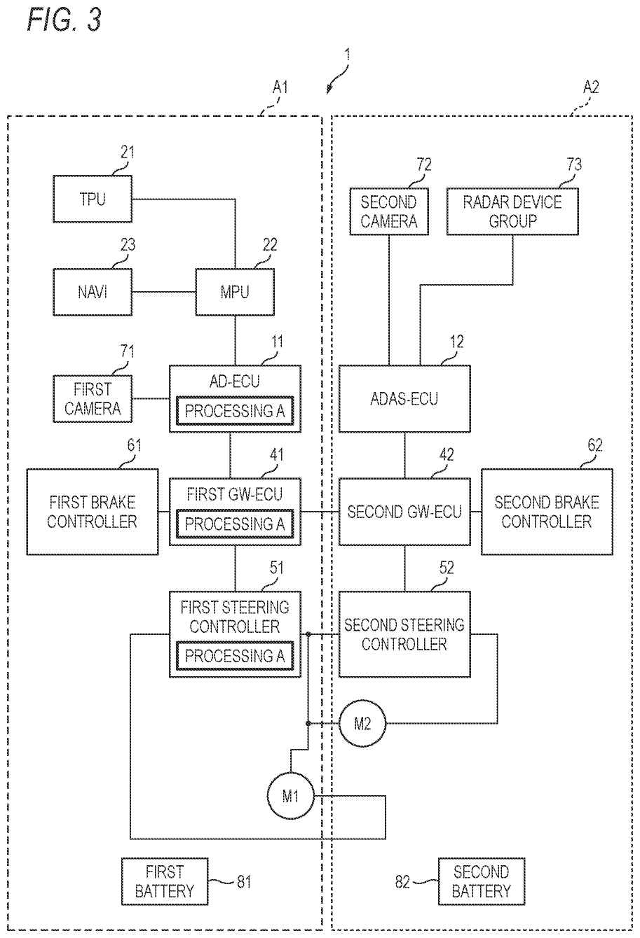

FIG. 3 is a schematic diagram showing another example of the distribution destination of the processing A. FIG. 3 shows an example in which the processing A to be performed by the AD-ECU 11 can be executed by each of the first GW-ECU 41 and the first steering controller 51. According to the distribution example shown in FIG. 3, since the processing A can be distributed to a plurality of control units, the same effect as in FIG. 2 can be obtained. For example, even when an abnormality occurs in the second battery 82 and each unit of the second system A2 becomes inoperable, the processing A can still be efficiently distributed.

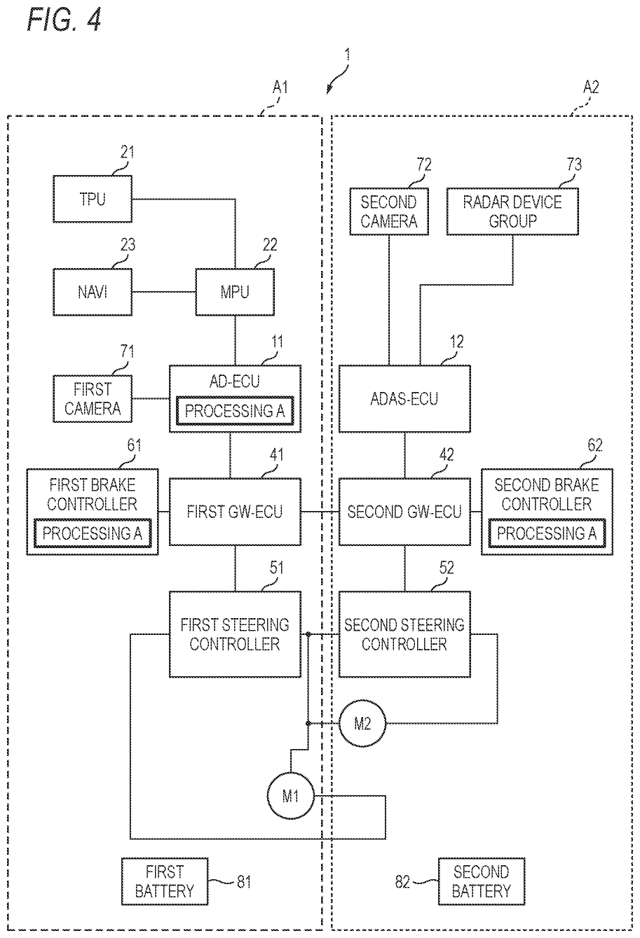

FIG. 4 is a schematic diagram showing another example of the distribution destination of the processing A. FIG. 4 shows an example in which the processing A to be performed by the AD-ECU 11 can be executed by each of the first brake controller 61 and the second brake controller 62. In this example, even when one of the first brake controller 61 and the second brake controller 62 becomes inoperable, the processing A can be executed by the other, so that the load on the AD-ECU 11 can be reduced.

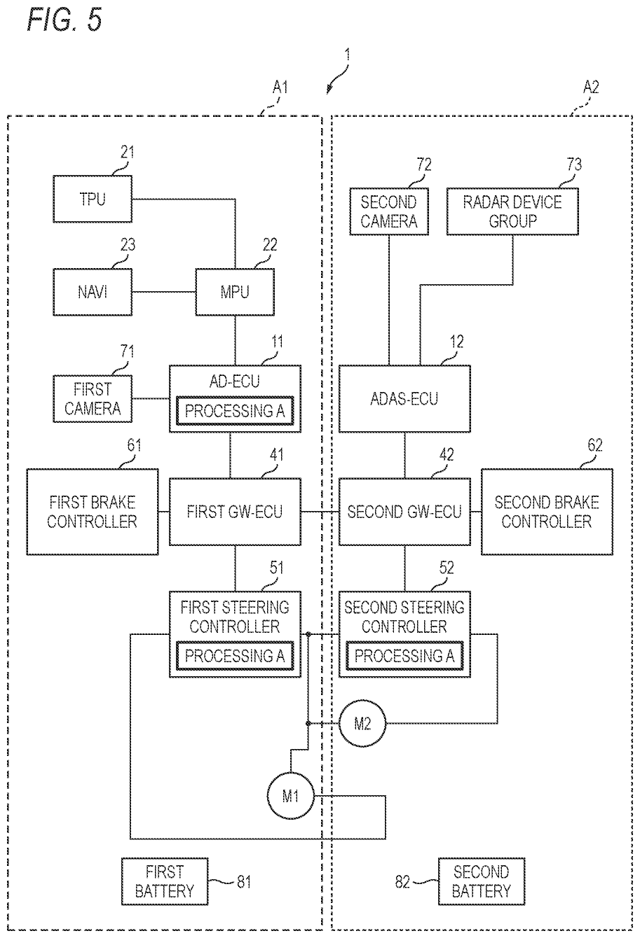

FIG. 5 is a schematic diagram showing another example of the distribution destination of the processing A. FIG. 5 shows an example in which the processing A to be performed by the AD-ECU 11 can be executed by each of the first steering controller 51 and the second steering controller 52. In this example, even when one of the first steering controller 51 and the second steering controller 52 becomes inoperable, the processing A can still be executed by the other, so that the load on the AD-ECU 11 can be reduced.

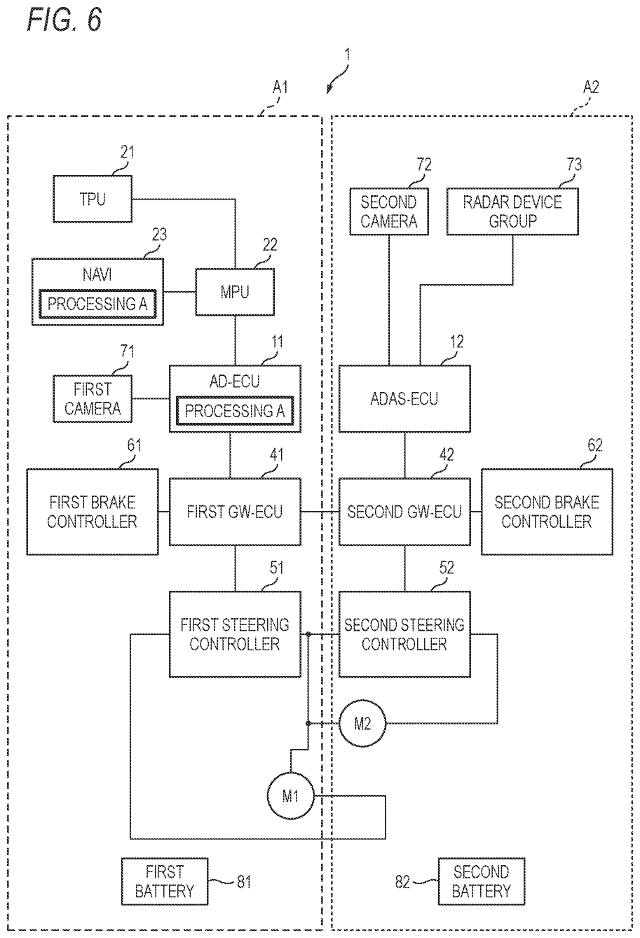

FIG. 6 is a schematic diagram showing another example of the distribution destination of the processing A. FIG. 6 shows an example in which the processing A to be performed by the AD-ECU 11 can be executed by the NAVI 23. The NAVI 23 is generally equipped with a high-performance processor and has an air-cooled cooling system. The NAVI 23 often does not operate at 100% load. In this way, by allowing the NAVI 23 with large surplus capacity to execute the processing A, loads on other control units other than the AD-ECU 11 can be reduced.

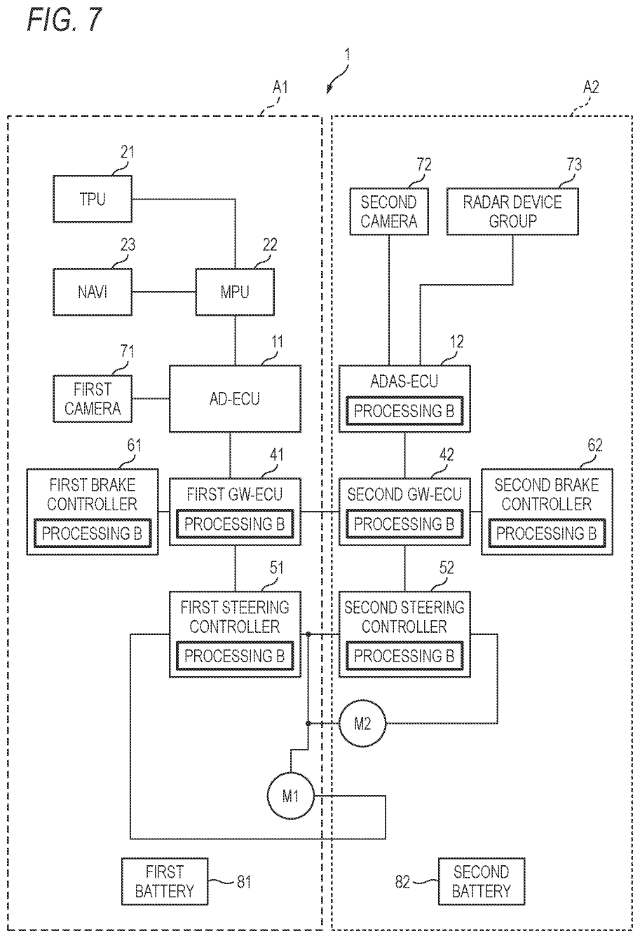

FIG. 7 is a schematic diagram showing an example of the distribution destination of the processing B. FIG. 7 shows an example in which the processing B to be performed by the ADAS-ECU 12 can be executed by at least one of the second GW-ECU 42, the second steering controller 52, the second brake controller 62, the first GW-ECU 41, the first steering controller 51, and the first brake controller 61. As shown in FIG. 7, similarly to the AD-ECU 11, the ADAS-ECU 12 can also reduce its own load by causing one or a plurality of other control units to execute the processing B.

Although an embodiment of the present disclosure has been described above with reference to the accompanying drawings, it is needless to say that the present disclosure is not limited to the embodiment. It is apparent that those skilled in the art can conceive of various modifications and changes within the scope described in the claims, and it is understood that such modifications and changes naturally fall within the technical scope of the present invention. In addition, the respective constituent elements in the above embodiment may be combined as desired without departing from the gist of the invention.

For example, in the above-described embodiment, a four-wheeled automobile was used as an example of the vehicle, but the present invention is not limited thereto. A vehicle to which the technique of the present disclosure can be applied may be a two-wheeled automobile (so-called motorcycle), a self-driving agricultural machine, a drone, or the like.

In the present description, at least the following matters are described. Corresponding constituent elements and the like in the embodiment described above are shown in parentheses, but the present invention is not limited thereto.

(1) A control device (control device 30) for a vehicle (vehicle 1), the control device including:
a first controller (AD-ECU 11); and
a second controller (first GW-ECU 41, first steering controller 51, first brake controller 61, second GW-ECU 42, second steering controller 52, second brake controller 62) controlled by the first controller, in which
the first controller is configured to transmit information used for first processing (processing A) necessary for travel control of the vehicle to the second controller,
the second controller is configured to perform the first processing based on the information received from the first controller, and transmit a result of the first processing to the first controller, and
the first controller is configured to perform travel control of the vehicle based on the result received from the second controller.

According to (1), since the second controller performs the first processing to be performed by the first controller, a load on the first controller can be reduced and heat generation can be prevented, and a cost for heat countermeasures can be reduced. Since the first controller can obtain a result of the first processing in parallel with other processing, the processing can be executed efficiently, and as the first controller, a device whose processing ability is not so high can be used. As a result, a manufacturing cost of the vehicle can be reduced. Even when an operating program of the first controller is updated and the number of types of processing increases after the vehicle is shipped, one or some types of the processing can be distributed to the second controller, and therefore, functions can be added without updating hardware.

(2) The control device for a vehicle according to (1), in which
the first controller is configured to transmit the information to the second controller when a processing load of the first controller exceeds a threshold.

According to (2), since the first controller performs the first processing when the processing load thereof is equal to or lower than the threshold, it is possible to perform the travel control based on the result at a high speed.

(3) The control device for a vehicle according to (1) or (2), in which
the second controller includes a first device (first GW-ECU 41) connected to the first controller, and a second device (first steering controller 51, first brake controller 61) connected to the first device.

According to (3), since the first processing can be executed by at least one of the first device and the second device, for example, when the processing load of the first controller is moderate, the first processing is performed by one of the first device and the second device, and when the processing load of the first controller is high, it becomes possible to perform the first processing by both the first device and the second device, and therefore, the processing can be performed more efficiently.

(4) The control device for a vehicle according to (3), in which
the first controller and the second controller is configured to operate with electric power from a first battery (first battery 81) mounted on the vehicle.

According to (4), for example, in a case where the vehicle includes a system that operates with the electric power of the first battery and a system that operates with the electric power of the second battery, even when the power supply from the second battery is interrupted, the processing performed by the first controller can be distributed between the first controller and the second controller that operate with the electric power from the same first battery. In this way, the first processing can be distributed with high accuracy.

(5) The control device for a vehicle according to (1), in which
the vehicle is equipped with a first battery (first battery 81) and a second battery (second battery 82),
the first controller includes a device (AD-ECU 11) operating with electric power from the first battery, and a device (ADAS-ECU 12) operating with electric power from the second battery, and
the second controller includes a device (first GW-ECU 41, first steering controller 51, first brake controller 61) operating with electric power from the first battery, and a device (second GW-ECU 42, second steering controller 52, second brake controller 62) operating with electric power from the second battery.

According to (5), for example, the processing performed by the device of the first controller can be distributed between the device of the first controller and the device of the second controller, which operate with the electric power from the first battery. Therefore, even when an abnormality occurs in the system operating with the second battery, the first processing can be distributed with high accuracy. Since the processing to be performed by the device of the first controller that operates with the electric power from the first battery can be distributed to the device of the second controller that operates with the electric power from the first battery, and the device of the second controller that operates with the electric power from the second battery, the processing load of the first controller can be further reduced by increasing the number of distribution destinations of the processing.

1. A control device for a vehicle, the control device comprising:
a first controller; and
a second controller controlled by the first controller, wherein
the first controller is configured to transmit information used for first processing necessary for travel control of the vehicle to the second controller,
the second controller is configured to perform the first processing based on the information received from the first controller, and transmit a result of the first processing to the first controller, and
the first controller is configured to perform travel control of the vehicle based on the result received from the second controller.

2. The control device for a vehicle according to claim 1, wherein
the first controller is configured to transmit the information to the second controller when a processing load of the first controller exceeds a threshold.

3. The control device for a vehicle according to claim 1, wherein
the second controller includes a first device connected to the first controller, and a second device connected to the first device.

4. The control device for a vehicle according to claim 3, wherein
the first controller and the second controller is configured to operate with electric power from a first battery mounted on the vehicle.

5. The control device for a vehicle according to claim 1, wherein
the vehicle is equipped with a first battery and a second battery,
the first controller includes a device operating with electric power from the first battery, and a device operating with electric power from the second battery, and
the second controller includes a device operating with electric power from the first battery, and a device operating with electric power from the second battery.
